(19) United States
(12) Patent Application Publication
(10) Pub. No.: US 2018/0238259 A1
(43) Pub. Date: Aug. 23, 2018

(54) METHOD AND DEVICE FOR DETECTING A FAULT DURING OPERATION OF AN INTERNAL COMBUSTION ENGINE

(71) Applicant: Robert Bosch GmbH, Stuttgart (DE)

(72) Inventors: Claus Wundling, Freiberg (DE); Rainer Ecker, Kornwestheim (DE); Thomas Kuhn, Heilbronn (DE); Timm Hollmann, Benningen A.N. (DE); Udo Schulz, Vaihingen/Enz (DE)

(21) Appl. No.: 15/751,408

(22) PCT Filed: Jul. 27, 2016
(86) PCT No.: PCT/EP2016/067884

§ 371 Date: Feb. 8, 2018

(30) Foreign Application Priority Data
Sep. 3, 2015 (DE) 10 2015 216 869.7

(51) Int. Cl. F02D 41/22; F02D 41/30; F02D 41/14

(52) U.S. Cl. CPC F02D 41/221; F02D 41/1454; F02D 41/3029

(57) ABSTRACT

A method for detecting a fault during operation of an internal combustion engine having manifold injection and direct injection; the internal combustion engine being controlled in two different combustion cycles, in each instance, for introducing a fuel quantity and a corresponding air quantity into a combustion chamber of the internal combustion engine, with different distributions of the fuel quantity to the manifold injection and the direct injection in the two combustion cycles; for each of the two combustion cycles, a value of a ratio of the air quantity introduced into the combustion chamber to the fuel quantity introduced into the combustion chamber being ascertained; and if at least one of the two values differs from a corresponding comparison value by more than a first threshold value, a type of fault during operation of the internal combustion engine being deduced in light of the difference.

### FIELD

The present invention relates to a method for detecting a fault during operation of an internal combustion engine having manifold injection and direct injection, as well as to an arithmetic unit and a computer program for implementing it.

### BACKGROUND INFORMATION

One possible method for fuel injection in spark ignition engines is manifold injection, which is increasingly being replaced by direct fuel injection. The latter leads to markedly better fuel distribution in the combustion chambers, and consequently, to better power output with lower fuel consumption.

In addition, there are also spark ignition engines having a combination of manifold injection and direct injection, a so-called dual system. In particular, in light of increasingly strict emissions requirements, that is, emissions limits, this is advantageous since, for example, in intermediate load ranges, manifold injection produces better emissions values than direct injection. However, direct injection allows, e.g., so-called knocking to be reduced in the full-load range.

In response to the occurrence of an unwanted air-to-fuel ratio in a combustion chamber of the internal combustion engine, which may be detected, for example, with the aid of an oxygen sensor, the air-to-fuel ratio may be adjusted by suitably modifying the control of the fuel injectors.

### SUMMARY

The present invention provides a method for detecting a fault during operation of an internal combustion engine, as well as an arithmetic unit and a computer program for its implementation. Advantageous refinements of the present invention are described herein.

Within the scope of the present invention, the type of the existing fault may be deduced very rapidly and simply by comparing the air-to-fuel ratios in the combustion chambers at varied distributions to the two types of injection, if at least one of the two values of the air-to-fuel ratios differs from an associated comparison value.

While, in the case of a simple determination of the air-to-fuel ratio, merely a fault during operation of the internal combustion engine may be deduced and the control of the fuel injectors may consequently be adjusted, an example embodiment of the method in accordance with the present invention also allows the type of fault during operation of the internal combustion engine to be identified. In this connection, it must be taken into account that a selected quantity of fuel is discharged, using corresponding activation times of the fuel injectors. In this context, however, the desired quantity of fuel is not discharged when the flow rate through the fuel injector is incorrect. In particular, a functional limitation of a fuel injector in question and a functional limitation in the air supply to the combustion chamber may be distinguished as different types of faults. Thus, in this manner, the exact cause of the fault may be pinpointed very easily, which allows, for example, the fault to be rectified more simply and rapidly.

The distribution of the quantity of fuel preferably includes pure manifold injection and pure direct injection. In this manner, differences in the air-to-fuel ratio may be detected particularly clearly in the two combustion cycles.

If only one of the two values differs from the associated comparison value by more than the first threshold value, then a functional limitation of a fuel injector of the injection type associated with the differing value is advantageously deduced. Thus, for example, a functional limitation of the fuel injector for the manifold injection may be deduced, if the value of the air-to-fuel ratio only differs noticeably from a comparison value or setpoint value in the case of pure manifold injection, but does not in the case of pure direct injection. In the case of too low a fuel quantity discharged by the fuel injector, an overly high air fraction is measured. Of course, this is also possible in the case of another, different distribution to the two types of injection, even though the difference also turns out to be not so great. In this case, the first threshold value may be selected suitably. Thus, this threshold value may be used, for example, to take into account any inaccuracies in measurement.

In this context, it may also preferably be provided, that a functional limitation only be deduced, if the two values also differ from one another by more than a second threshold value. The second threshold value may also be used for taking possible measurement inaccuracies into account. In particular, a fault may therefore be prevented from being deduced, if only one of two values differs by more than the first threshold value, but the two values only differ from one another slightly. In this manner, it is therefore possible to detect a functional limitation of a fuel injector in a highly simple manner.

It is advantageous if the functional limitation of the fuel injector includes a defect, a partial defect, or contamination as different types of the functional limitation; in particular, in light of the magnitude of the difference of the value in question from the corresponding comparison value, the type of difference is deduced. In this manner, even more accurate identification of the type of fault is possible. Thus, for example, in the case of an indeed noticeable, but still relatively small difference of the value, contamination, e.g., in the form of layers, in or on the fuel injector may be deduced. Contamination would result in a lower flow rate in the fuel injector in question, which, with the same activation times, would lead to a fuel quantity lower than the desired one. In the event of large differences, a partial defect or a defect may also be deduced. To this end, reasonable differences may be established, which may be ascertained, e.g., with the aid of test measurements. In the case of a defect, the fuel injector in question may also be used less or switched off, in order to prevent any further problems, such as the overheating of a catalytic converter.

If the two values differ from the respective, corresponding comparison value by more than the first threshold value, then, preferably, a functional limitation in an air supply for the combustion chamber, in particular, an air-mass metering, is deduced. In this context, use is made of the fact that the air supply to the internal combustion engine is used for both types of injection. Thus, if a difference occurs in both cases, then it is to be assumed that the fault lies in the system used jointly, since it is highly unlikely for the same faults to occur in two different fuel injectors. In this context, an overly high quantity of air supplied to the combustion chamber would produce an overly high air fraction, and an overly low air quantity supplied to the combustion chamber would lead to an overly low air fraction of the mixture in the combustion chamber. In this case, the first threshold value may be selected suitably. Thus, this may be used, for example, to take into account possible inaccuracies in measurement, as was mentioned above.

In this context, it may also preferably be provided, that a functional limitation only be deduced, if the two values differ from one another by less than a third threshold value. The third threshold value may also be used to take into account possible measurement inaccuracies. By this, in particular, a fault may be prevented from being deduced, if the two values do noticeably differ from the comparison value, but would also not be overriding within the scope of the measurement inaccuracy. In the same way, a possible difference of the two values on the basis of the different type of injection and, in some instances, accompanying, further effects, such as valve control times, may therefore be considered. In this manner, it is therefore possible to detect a functional limitation of the air supply in a highly simple manner. In particular, a malfunction of an air-mass flow rate sensor may be deduced, using this.

It is advantageous, if the ratio of the quantity of air introduced into the combustion chamber to the quantity of fuel introduced into the combustion chamber is ascertained with the aid of an oxygen sensor, an engine speed fluctuation in the combustion cycle in question, and/or a pressure sensor in the combustion chamber. An oxygen sensor is, for example, already present in an internal combustion engine. An engine speed fluctuation is caused, for example, when a torque that is too low is generated due to too small a quantity of fuel in the combustion chamber during combustion. Using the pressure sensor, a pressure of the air-fuel mixture in the combustion chamber may be ascertained, the pressure being influenced by the fraction of fuel in the mixture. As a rule, the ratio may be determined sufficiently accurately with the aid of one of the methods, but the use of a plurality of these methods may be more accurate.

The type of fault is preferably ascertained for each combustion chamber of the internal combustion engine. In this manner, e.g., each of the fuel injectors of the internal combustion engine may be monitored. In the case of a common fuel injector for a plurality of combustion chambers, then, for the manifold injection, it may also possibly be sufficient to take the measurement for pure manifold injection only once, while, for the pure direct injection, it is taken for each combustion chamber. Nonetheless, in the case of the manifold injection, the measurement may also be taken for each combustion chamber, in order to obtain more accurate values.

If the ratios of the quantities of air introduced into the combustion chambers to the respective quantities of fuel introduced into the combustion chambers are ascertained with the aid of an oxygen sensor for a plurality of combustion chambers, then the corresponding ratios of the individual combustion chambers are advantageously ascertained in view of valve control times, gas transit times, and/or reaction times of the oxygen sensor. In this case, use is made of the fact that in view of the gas transit times and, e.g., the exhaust valve opening times, the air-to-fuel ratio value of an individual combustion chamber may be deduced when the air-to-fuel ratio signal is highly resolved over time. In this manner, the example method according to the present invention may also be executed, if only one oxygen sensor is provided for a plurality of combustion chambers, that is, not a separate oxygen sensor for each combustion chamber.

It is advantageous when differences of the values from the comparison values and/or from each other are ascertained relatively or, in particular, ascertained absolutely, when, in the two combustion cycles, at least substantially the same fuel quantity and air quantity are specified. When relative differences are used, possible incorrect results, which, for example, in the case of different fuel quantities for the two combustion cycles, e.g., with different torque requests to the internal combustion engine, may be prevented. However, in the case of fuel quantities that are at least substantially equal, e.g., in the case of consecutive combustion cycles, absolute differences may be used, with the aid of which more accurate results may be obtained, generally.

An arithmetic unit of the present invention, e.g., a control unit, in particular, an engine control unit, of a motor vehicle, is configured, in particular, in the form of software, to implement a method of the present invention.

The implementation of the method in the form of a computer program is also advantageous, since this generates particularly low costs, in particular, if an implementing control unit is still used for other tasks and is therefore already present.

Suitable storage media for supplying the computer program include, in particular, magnetic, optical, and electrical storage devices, such as hard drives, flash drives, EEPROMs, DVDs, etc. A download of a program via computer networks (Internet, intranet, etc.) is also possible.

Further advantages and refinements of the present invention are derived from the description and the accompanying drawing.

The present invention is represented schematically in the figures in light of an exemplary embodiment, and described below with reference to the fgures.

### BRIEF DESCRIPTION OF THE DRAWINGS

FIGS. 1a and 1b schematically show two internal combustion engines, which may be utilized for a method of the present invention.

FIG. 2 schematically shows a cylinder of an internal combustion engine, which may be utilized for a method of the present invention.

FIG. 3 shows possible types of faults in a preferred specific embodiment of a method according to the present invention.

FIG. 4 schematically shows a flowchart of a preferred specific embodiment of a method according to the present invention.

### DETAILED DESCRIPTION OF EXAMPLE EMBODIMENTS

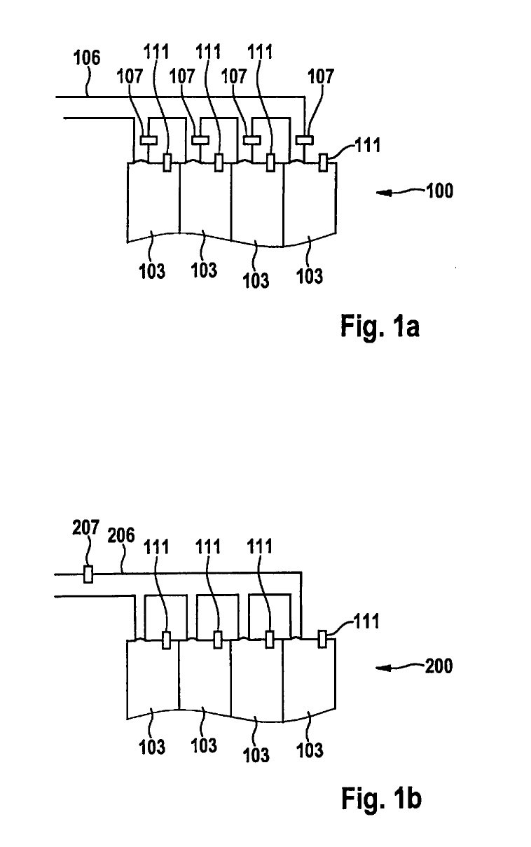

An internal combustion engine 100, which may be utilized for a method of the present invention, is shown schematically in FIG. 1a in a simplified manner. By way of example, internal combustion engine 100 includes four combustion chambers 103 and an intake manifold 106, which is connected to each of combustion chambers 103.

In this context, intake manifold 106 includes a fuel injector 107 for each combustion chamber 103, the fuel injector being situated, in each instance, in the section of the intake manifold just in front of the combustion chamber. Therefore, fuel injectors 107 are used for manifold injection. In addition, each combustion chamber 103 includes a fuel injector 111 for direct injection.

A further internal combustion engine 200, which may be utilized for a method of the present invention, is shown schematically in FIG. 1b in a simplified manner. By way of example, internal combustion engine 100 includes four combustion chambers 103 and an intake manifold 206, which is connected to each of combustion chambers 103.

In this context, intake manifold 206 has a common fuel injector 207 for all of the combustion chambers 103, the common fuel injector being situated, for example, in the intake manifold, just after a throttle valve not shown here. Therefore, first fuel injector 207 is used for manifold injection. In addition, each combustion chamber 103 includes a fuel injector 111 for direct injection.

Consequently, the two internal combustion engines 100 and 200 shown have a so-called dual system, that is, manifold injection and direct injection. The only difference is the type of manifold injection. While, for example, the manifold injection shown in FIG. 1a allows fuel to be metered individually for each combustion chamber, as may be used, for example, for higher-quality internal combustion engines, the manifold injection shown in FIG. 1b is simpler in its design and in its control. The two internal combustion engines shown may be, in particular, spark ignition engines.

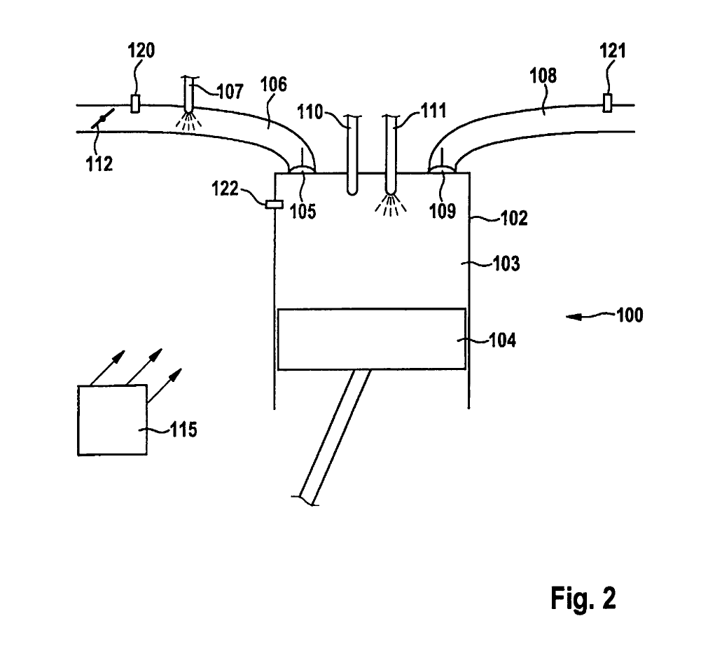

In FIG. 2, a cylinder 102 of internal combustion engine 100 is represented schematically and in a simplified manner, but more detailed than in FIG. 1a. Cylinder 102 includes a combustion chamber 103, which is increased or decreased in size via the motion of a piston 104. The internal combustion engine at hand may be, in particular, a spark ignition engine.

Cylinder 102 includes an intake valve 105, in order to let in air or a fuel-air mixture into combustion chamber 103. The air is fed through intake manifold 106 as part of an air supply, fuel injector 107 being situated on the intake manifold. Air drawn in is let into combustion chamber 103 of cylinder 102 via intake valve 105. A throttle valve 112 in the air supply system is used for setting the necessary mass flow rate of air into cylinder 102. Using an air-mass flow rate sensor 120, e.g., in the form of a hot-film air-mass flow rate sensor, the quantity of air to be introduced into combustion chamber 103 via intake manifold 106 may be ascertained.

The internal combustion engine may be operated in accordance with manifold injection. In the course of this manifold injection, fuel is injected into intake manifold 106 with the aid of fuel injector 107, which means that an air-fuel mixture forms there, which is let into combustion chamber 103 of cylinder 102 via intake valve 105. A pressure sensor 122 is provided in combustion chamber 103, a pressure of an air-fuel mixture contained in the combustion chamber being able to be ascertained with the aid of the pressure sensor.

The internal combustion engine may also be operated in accordance with direct injection. For this purpose, fuel injector 111 is mounted to cylinder 102, in order to inject fuel directly into combustion chamber 103. In the case of this direct injection, the air-fuel mixture needed for the combustion is formed directly in combustion chamber 103 of cylinder 102.

Cylinder 102 is also provided with an ignition device 110, in order to produce a spark for starting combustion in combustion chamber 103.

After combustion, exhaust gases of combustion are expelled from cylinder 102 through an exhaust pipe 108. The expulsion takes place as a function of the opening of an exhaust valve 109, which is also situated on cylinder 102. Intake and exhaust valves 105, 109 are opened and closed, in order to implement a four-stroke operation of internal combustion engine 100 in a conventional manner. An oxygen sensor 121 is provided in exhaust pipe 108, a residual oxygen content in the exhaust gas being able to be ascertained with the aid of the oxygen sensor, and an air-to-fuel ratio in the combustion chamber being able to be back-calculated, in turn, from the residual oxygen content in the exhaust gas.

Internal combustion engine 100 may be operated, using direct injection, using manifold injection, or in a mixed mode. This allows the optimum operating mode to be selected, in each instance, for operating internal combustion engine 100 as a function of the current operating point. Thus, internal combustion engine 100 may be operated, for example, in a manifold injection mode, when it is operated at low speed and low load, and it may be operated in a direct injection mode, when it is operated at high speed and high load. However, over a large operating range, it is practical to operate internal combustion engine 100 in a mixed mode, in which the quantity of fuel to be supplied to combustion chamber 103 is supplied proportionally by manifold injection and direct injection.

In addition, an arithmetic unit taking the form of a control unit 115 is provided for controlling internal combustion engine 100. Control unit 115 may operate internal combustion engine 100, using direct injection, manifold injection or the mixed mode. Furthermore, control unit 115 may also acquire values from air-mass flow rate sensor 120, from oxygen sensor 121, as well as from pressure sensor 122.

The method of functioning of internal combustion engine 100 described in further detail with reference to FIG. 2 may also be applied to the internal combustion engine 200 according to FIG. 1b, the only difference being that just one common fuel injector is provided for all of the combustion chambers or cylinders. Thus, in the case of manifold injection and/or in the case of mixed mode, the single fuel injector in the intake manifold is controlled.

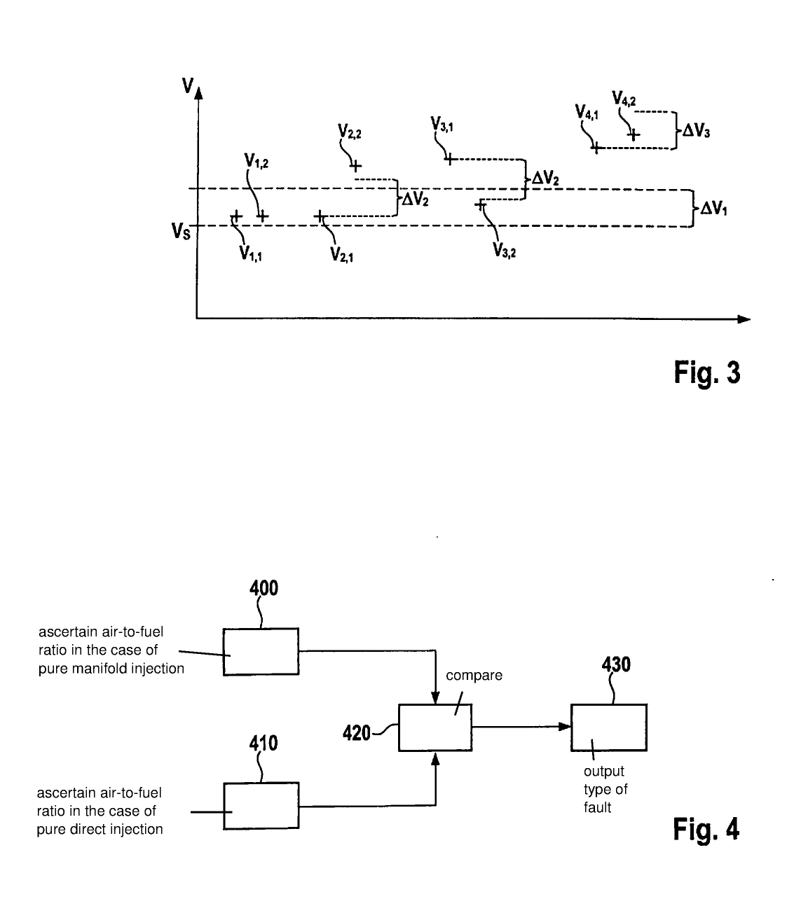

In FIG. 3, possible types of faults are shown in a preferred specific embodiment of a method according to the present invention. To that end, an air-to-fuel ratio V is plotted on the vertical axis.

A comparison value, which is intended, in this case, to apply to the two values, that is, e.g., both the values ascertained with the aid of pure manifold injection and the values ascertained with the aid of pure direct injection, is referred to by Vₛ. This may be achieved in that, e.g., the ascertained values of the air-to-fuel ratios for, in each instance, the same fuel quantity and air quantity are determined and/or specified relative to the quantity of fuel to be introduced.

Such a comparison value may be a setpoint value, which is intended to be reached, as a rule, in an injection operation. A first, a second and a third threshold value are referred to as ΔV₁, ΔV₂ and ΔV₃. The three threshold values may be selected, e.g., to be of equal value, e.g., to be 5% or 10% of the comparison value. Of course, the threshold values may also be selected to be different or variable as a function of requirement and/or measurement accuracy.

In addition, different values in the form V_{x,1} and V_{x,2} are shown, the 1 and 2 in the index standing for the type of injection, in this case, e.g., pure manifold injection and pure direct injection. The x in the index stands for the number of the example to be explained.

In the first case, values V_{1,1} and V_{1,2,} that is, the air-to-fuel ratios for the manifold and the direct injection, are of substantially equal value, and simultaneously, both differ from comparison value Vₛ by less than first threshold value ΔV₁. In the case at hand, this means that within the scope of the measurement accuracy, the two values may still correspond to the comparison value. This being the case, a fault is not deduced here.

In the second case, values V_{2,1} and V_{2,2} are different. In this context, only value V_{2,2} differs from comparison value Vₛ by more than first threshold value ΔV₁, while value V_{2,1} differs from comparison value Vₛ by less than first threshold value ΔV₁. In addition, however, the two values V_{2,1} and V_{2,2} differ from each other by more than second threshold value ΔV₂.

In this case, this means that the two values are different from one another within the scope of the measurement accuracy, and that at the same time, only value V_{2,2} differs from comparison value Vₛ within the scope of the measurement accuracy. This being the case, it may be assumed, here, that a functional limitation is present in the fuel injector, which belongs to value V_{2,2}, thus, in this case, a fuel injector for the direct injection. Since a noticeable difference in the air-to-fuel ratio is present only in one of the two different types of injection, it may be assumed that no fault is present, which would have an effect on the two types of injection.

In the third case, values V_{3,1} and V_{3,2} are different. In this context, only the value V_{3,1} differs from comparison value Vₛ by more than first threshold value ΔV₁, while the value V_{3,2} differs from comparison value Vs by less than first threshold value ΔV₁. This case corresponds to the second case with values exchanged, i.e., here, a functional limitation is present in the manifold injection. In all other respects, reference is made to the explanations regarding the second case. However, for example, in the second and third cases, the comparison to the second threshold value may also be omitted, if a sufficiently high measurement accuracy of the values is present. Then, a functional limitation may only be deduced on the basis of the difference of only one of the two values by more than the first threshold value.

Regarding the functional limitations of the fuel injectors, as are shown, for example, in the second and third cases, it should be noted that, for example, the type of functional limitation may be deduced on the basis of the magnitude of the difference of the respective value from the comparison value. Thus, for example, in the event of a difference of 10%, acceptable contamination of the fuel injector may be assumed, while with 30% or 40%, a partial defect or a defect may be assumed. In the case of fuel injectors for direct injection, a certain degree of flow-rate reduction, which occurs after a particular operating time in comparison with the new condition, is accepted (for example, ca. 10% flow-rate reduction in comparison with the new condition). If the flow-rate reduction exceeds this 10% significantly, then, in the case of pure manifold injection systems, engine failure may occur in some instances, since the air-to-fuel ratio control may reach a limit. Of course, these percentages are selected to be merely illustrative and may be adjusted as a function of the situation. In addition, e.g., a different difference may be utilized in the different types of injection.

In the fourth case, values V_{4,1} and V_{4,2} differ from each other by less than third threshold value ΔV₃, and the two values differ from comparison value Vₛ by more than first threshold value ΔV₁. This being the case, it may be assumed that the two values are equal within the scope of the measurement accuracy. Therefore, it is to be assumed that a cause of a fault is present, which is involved in both types of injection, it being the supply of air to the combustion chamber. In this case, as a rule, the air-mass flow rate sensor is affected.

A flow chart of a preferred specific embodiment of a method according to the present invention is schematically represented in FIG. 4. In a step 400, the air-to-fuel ratio may initially be ascertained in the case of pure manifold injection. Subsequently, in a step 410, the air-to-fuel ratio may be ascertained in the case of pure direct injection. Of course, these two steps may also be executed in reverse temporal order.

Then, in a step 420, the values of the air-to-fuel ratios obtained in this manner may be compared to respective comparison values. Subsequently, in a step 430, a type of the fault, which is present and has been ascertained, may be outputted, that is, e.g., stored in a control unit memory and/or outputted as a warning to a driver.

1-14. (canceled)

15. A method for detecting a fault during operation of an internal combustion engine having manifold injection and direct injection. the method comprising:
controlling the internal combustion engine in two different combustion cycles, in each instance, for introducing a fuel quantity and a corresponding air quantity into a combustion chamber of the internal combustion engine, with different distribution of the fuel quantity to the manifold injection and the direct injection in each of the two combustion cycles;
for each of the two combustion cycles, ascertaining a value of a ratio of the air quantity introduced into the combustion chamber to the fuel quantity introduced into the combustion chamber; and
if at least one of the two values differs from a corresponding comparison value by more than a first threshold value, deducing a type of the fault during operation of the internal combustion engine in light of the difference.

16. The method as recited in claim 15, wherein the distribution of the fuel quantity includes a pure manifold injection and a pure direct injection.

17. The method as recited in claim 15, wherein if only one of the two values differs from the corresponding comparison value by more than the first threshold value, a functional limitation of a fuel injector of the injection type belonging to the differing value is deduced.

18. The method as recited in claim 17, wherein a functional limitation of the fuel injector is only deduced, if, in addition, the two values also differ from one another by more than a second threshold value.

19. The method as recited in claim 17, wherein the functional limitation of the fuel injector includes one of a defect, a partial defect, or contamination, as different types of the functional limitation, and in light of a magnitude of the difference of the respective value from the corresponding comparison value, the type of difference is deduced.

20. The method as recited in claim 15, wherein if the two values differ from the respective, corresponding comparison value by more than the first threshold value, a functional limitation in an air supply in an air-mass metering for the combustion chamber is deduced.

21. The method as recited in claim 20, wherein a functional limitation in an air supply is only deduced, if, in addition, the two values also differ from one another by less than a third threshold value.

22. The method as recited in claim 15, wherein the ratio of the air quantity introduced into the combustion chamber to the fuel quantity introduced into the combustion chamber is ascertained with the aid of at least one of: (i) an oxygen sensor, (ii) an engine speed fluctuation in the respective combustion cycle, and (iii) a pressure sensor in the combustion chamber.

23. The method as recited in claim 15, wherein the type of fault is ascertained for each combustion chamber of the internal combustion engine.

24. The method as recited in claim 23, wherein if the ratios of the air quantities introduced into the combustion chambers to the respective fuel quantities introduced into the combustion chambers are ascertained for a plurality of combustion chambers with the aid of an oxygen sensor, the corresponding ratios of the individual combustion chambers are ascertained in view of at least one of valve control times, gas transit times, and reaction times of the oxygen sensor.

25. The method as recited in claim 1, wherein differences at least one of: of the values from the comparison values, and from each other are ascertained one of relatively or absolutely, if, in the two combustion cycles, at least substantially the same fuel quantity and air quantity are specified.

26. An arithmetic unit, which is configured to detect a fault during operation of an internal combustion engine having manifold injection and direct injection. the arithmetic unit configured to:
control the internal combustion engine in two different combustion cycles, in each instance, for introducing a fuel quantity and a corresponding air quantity into a combustion chamber of the internal combustion engine, with different distribution of the fuel quantity to the manifold injection and the direct injection in each of the two combustion cycles;
for each of the two combustion cycles, ascertain a value of a ratio of the air quantity introduced into the combustion chamber to the fuel quantity introduced into the combustion chamber; and
if at least one of the two values differs from a corresponding comparison value by more than a first threshold value, deduce a type of the fault during operation of the internal combustion engine in light of the difference.

27. A non-transitory machine-readable storage medium on which is stored a computer program for detecting a fault during operation of an internal combustion engine having manifold injection and direct injection. the computer program, when executed by a processor, causing the processor to perform:
controlling the internal combustion engine in two different combustion cycles, in each instance, for introducing a fuel quantity and a corresponding air quantity into a combustion chamber of the internal combustion engine, with different distribution of the fuel quantity to the manifold injection and the direct injection in each of the two combustion cycles;
for each of the two combustion cycles, ascertaining a value of a ratio of the air quantity introduced into the combustion chamber to the fuel quantity introduced into the combustion chamber; and
if at least one of the two values differs from a corresponding comparison value by more than a first threshold value, deducing a type of the fault during operation of the internal combustion engine in light of the difference.
